(19) United States
(12) Patent Application Publication
(10) Pub. No.: US 2006/0029828 A1
(43) Pub. Date: Feb. 9, 2006

(54) Organic electroluminescent device

(76) Inventors: Hiroshi Kanno, Osaka (JP); Kenji Okumoto, Osaka (JP); Yuji Hamada, Ikoma-gun (JP); Haruhisa Hashimoto, Osaka (JP); Masahiro Iyori, Osaka (JP); Kazuki Nishimura, Osaka (JP)

Correspondence Address: MCDERMOTT WILL & EMERY LLP, 600 13TH STREET, N.W., WASHINGTON, DC, 20005-3096, US

(21) Appl. No.: 11/087,716

(22) Filed: Mar. 24, 2005

(30) Foreign Application Priority Data
Mar. 25, 2004 (JP) 2004-089207
Jul. 29, 2004 (JP) 2004-222458
Feb. 28, 2005 (JP) 2005-053718

(51) Int. Cl. H05B 33/12

(52) U.S. Cl. 428/690; 428/917; 428/212; 313/504; 313/506

(57) ABSTRACT

An organic EL device has a structure that includes a hole injecting electrode, hole injecting layer, hole transporting layer, light emitting layer, electron restricting layer, electron transporting layer, and electron injecting electrode, in sequence, on a substrate. For the electron restricting layer, a material having an electron mobility lower than that of the electron transporting layer or a material having a low LUMO (lowest unoccupied molecular orbital) energy level is used.

### BACKGROUND OF THE INVENTION

1. Field of the Invention

The present invention relates to organic electroluminescent devices.

2. Description of the Background Art

With the recent diversification of information equipment, there is a growing need for flat panel displays that require lower power consumption than commonly used CRTs (cathode ray tubes). As one of such flat panel displays, organic electroluminescent devices (hereinafter abbreviated to organic EL devices) having such features as high efficiency, thinness, lightweight, and low viewing angle dependency have attracted attention.

An organic EL device has a structure that includes, in sequence, a hole transporting layer, light emitting layer, and electron transporting layer between hole injecting electrode and electron injecting electrode.

In conventional organic EL devices, in general, tris(8-hydroxyquinolinato)aluminum (hereinafter abbreviated to Alq₃), for example, has been widely used for an electron transporting layer.

The above-mentioned Alq₃, however, has low electron mobility. Therefore, using Alq₃ as an electron transporting layer increases drive voltage and power consumption in an attempt to inject sufficient electrons to the light emitting layer.

Appl. Phys. Lett., Vol. 76, No. 2, 10 Jan. 2000, p197-199 reported a phenanthroline derivative as a material having an electron mobility higher than that of Alq₃. Appl. Phys. Lett., Vol. 80, No. 2, 14 Jan. 2002, p189-191 further reported a silole derivative as a material having an electron mobility higher than that of Alq₃. Using the organic material with high electron mobility for an electron transporting layer can provide for a great reduction in drive voltage.

However, when such a high electron mobility material as disclosed in the above-mentioned Appl. Phys. Lett., Vol. 76, No. 2, 10 Jan. 2000, p197-199 or Appl. Phys. Lett., Vol. 80, No. 2, 14 Jan. 2002, p189-191 is used for an electron transporting layer, a region where electrons and holes recombine in an organic EL device shifts toward the hole injecting electrode, resulting in increased amount of electrons that reach the hole transporting layer. A triphenylamine derivative, typically used as the material of a hole transporting layer, becomes very unstable upon accepting electrons, and deteriorates. This results in a shortened luminescent lifetime of the organic EL device.

For an organic EL device having two or more light emitting layers, if the electron-hole recombination region shifts toward the hole injecting electrode, the emission intensity for a light emitting layer closer to the hole injecting electrode becomes higher than that of a light emitting layer closer to the electron injecting electrode, which prevents emission in a desired color.

### SUMMARY OF THE INVENTION

An object of the present invention is to provide an organic electroluminescent device having a low drive voltage and long lifetime.

Another object of the present invention is to provide an organic electroluminescent device having a low drive voltage and enabling emission in a desired color.

An organic electroluminescent device according to the present invention comprises, in sequence, a hole injecting electrode, light emitting layer, and electron injecting electrode; and an electron transporting layer that encourages transport of electrons and an electron restricting layer that restricts transfer of electrons between the light emitting layer and the electron injecting electrode.

The present organic electroluminescent device includes, between the light emitting layer and electron injecting electrode, the electron transporting layer that encourages transport of electrons. This allows for efficient injection of electrons to the light emitting layer, resulting in a lower drive voltage of the organic electroluminescent device.

In addition, the electron restricting layer that restricts transfer of electrons is provided between the light emitting layer and electron injecting electrode. The electron restricting layer restricts transfer of electrons from the electron injecting electrode to the light emitting layer, causing the hole-electron recombination region to shift toward the electron injecting electrode. This decreases the electrons passing through the light emitting layer without recombining with holes to reach a layer on the hole injecting electrode side. As a result, the layer on the hole injecting electrode side can be prevented from deterioration due to electrons, enabling a longer luminescent lifetime of the organic electroluminescent device.

For the electron restricting layer, a material having an electron mobility lower than that of the electron transporting layer is selected.

The electron restricting layer may be provided between the light emitting layer and the electron transporting layer. In this case, the electron transporting layer encourages transport of electrons, which decreases the drive voltage of the organic electroluminescent device. Moreover, the presence of the electron restricting layer prevents deterioration of the layer on the hole injecting electrode side, enabling a longer luminescent lifetime of the organic electroluminescent device.

The electron restricting layer may be provided between the electron transporting layer and the electron injecting electrode. In this case, the electron transporting layer encourages transport of electrons, which decreases the drive voltage of the organic electroluminescent device. Moreover, the presence of the electron restricting layer prevents deterioration of the layer on the hole injecting electrode side, enabling a longer luminescent lifetime of the organic electroluminescent device.

The electron restricting layer may have an energy level of the lowest unoccupied molecular orbital lower than that of the electron transporting layer. This ensures the restriction of electrons injected from the electron transporting layer to the electron restricting layer, thus reliably preventing the layer on the hole injecting electrode side from deterioration due to electrons. This ensures an extended luminescent lifetime of the organic electroluminescent device.

The electron restricting layer may include an organic compound having a molecular structure represented by a formula (1): 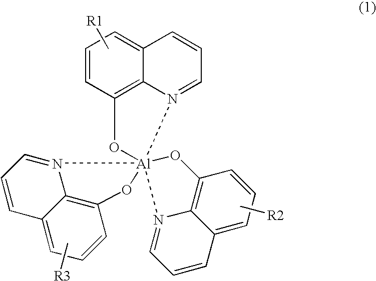
wherein R1, R2 and R3 are the same or different, each being a hydrogen atom, halogen atom or alkyl group. This decreases the energy level of the lowest unoccupied molecular orbital of the electron restricting layer while decreasing the electron mobility of the electron restricting layer. This sufficiently inhibits electrons from reaching the layer on the hole injecting electrode side, resulting in a sufficiently extended luminescent lifetime of the organic electroluminescent device.

The electron restricting layer may include tris(8-hydroxyquinolinato)aluminum having a molecular structure represented by a formula (2):

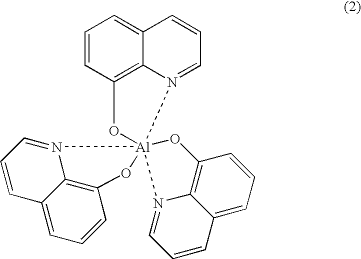

This decreases the energy level of the lowest unoccupied molecular orbital of the electron restricting layer while decreasing the electron mobility of the electron restricting layer. This sufficiently inhibits electrons from reaching the layer on the hole injecting electrode side, resulting in a sufficiently extended luminescent lifetime of the organic electroluminescent device.

The electron restricting layer may include an organic compound having a molecular structure represented by a formula (3): 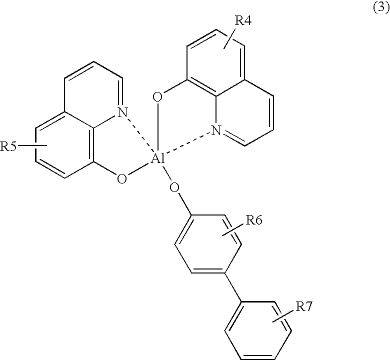
wherein R4, R5, R6 and R7 are the same or different, each being a hydrogen atom, halogen atom or alkyl group. This decreases the energy level of the lowest unoccupied molecular orbital of the electron restricting layer while decreasing the electron mobility of the electron restricting layer. This sufficiently inhibits electrons from reaching the layer on the hole injecting electrode side, resulting in a sufficiently extended luminescent lifetime of the organic electroluminescent device.

The electron restricting layer may include an anthracene derivative. This decreases the energy level of the lowest unoccupied molecular orbital of the electron restricting layer while decreasing the electron mobility of the electron restricting layer. This sufficiently inhibits electrons from reaching the layer on the hole injecting electrode side, resulting in a sufficiently extended luminescent lifetime of the organic electroluminescent device.

The electron restricting layer may include tert-butyl substituted dinaphthylanthracene having a molecular structure represented by a formula (4):

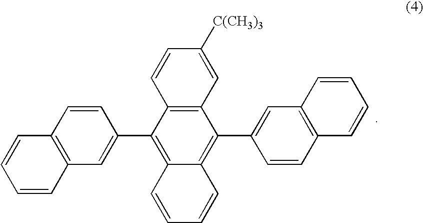

This decreases the energy level of the lowest unoccupied molecular orbital of the electron restricting layer while decreasing the electron mobility of the electron restricting layer. This sufficiently inhibits electrons from reaching the layer on the hole injecting electrode side, resulting in a sufficiently extended luminescent lifetime of the organic electroluminescent device.

The electron transporting layer may include a phenanthroline compound. This sufficiently encourages transfer of electrons, enabling a sufficient decrease in the drive voltage of the organic electroluminescent device.

The electron transporting layer may include 1,10-phenanthroline having a molecular structure represented by a formula (5) or a derivative thereof:

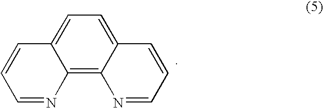

This sufficiently encourages transfer of electrons, enabling a sufficient decrease in the drive voltage of the organic electroluminescent device.

The electron transporting layer may include a phenanthroline derivative having a molecular structure represented by a formula (6): 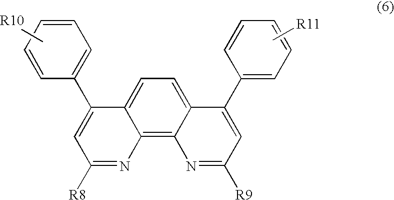
wherein R8, R9, R10 and R11 are the same or different, each being a hydrogen atom, halogen atom, aliphatic substituent or aromatic substituent. This sufficiently encourages transfer of electrons, enabling a sufficient decrease in the drive voltage of the organic electroluminescent device.

The electron transporting layer may include 2,9-Dimethyl-4,7-diphenyl-1,10-phenanthroline having a molecular structure represented by a formula (7):

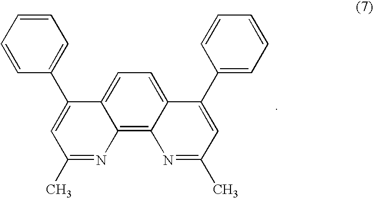

This sufficiently encourages transfer of electrons, enabling a sufficient decrease in the drive voltage of the organic electroluminescent device.

The electron transporting layer may include a silole derivative having a molecular structure represented by a formula (8): 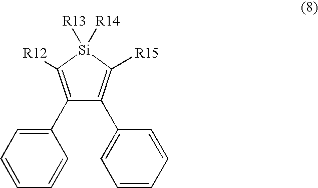
wherein R12, R13, R14 and R15 are the same or different, each being a hydrogen atom, halogen atom, aliphatic substituent or aromatic substituent. This sufficiently encourages transfer of electrons, enabling a sufficient decrease in the drive voltage of the organic electroluminescent device.

The light emitting layer may include a host material and a luminescent dopant. This results in improved luminous efficiency of the organic electroluminescent device.

The host material may include any of an anthracene derivative, aluminum complex, rubrene derivative, and arylamine derivative. This results in improved luminous efficiency of the organic electroluminescent device.

The luminescent dopant may include a material whose triplet excitation energy can be converted to emission. This results in further improved luminous efficiency of the organic electroluminescent device.

The host material may include tert-butyl substituted dinaphthylanthracene represented by the formula (4): 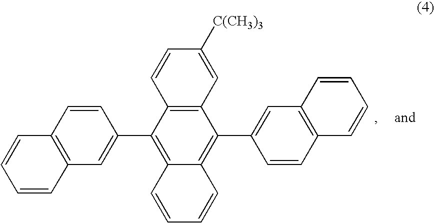
the luminescent dopant may include 1,4,7,10-Tetra-tert-butylPerylene represented by a formula (9): 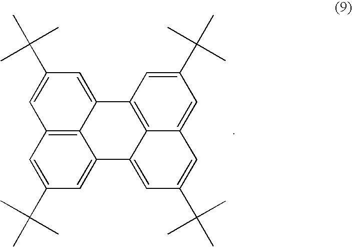
This provides for efficient extraction of blue emission.

The host material may include

N,N′-Di(1-naphthyl)-N,N′-diphenyl-benzidine represented by a formula (10): 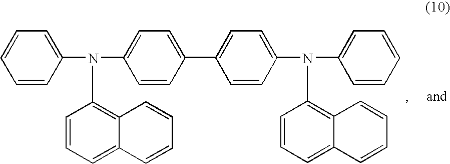
the luminescent dopant may include 5,12-Bis(4-tert-butylphenyl)-naphthacene represented by a formula (11):

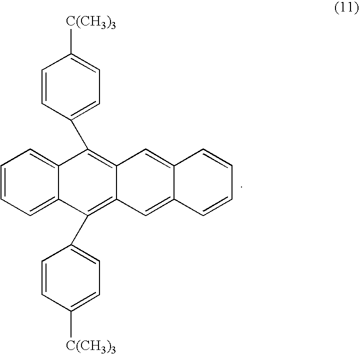

This provides for efficient extraction of green emission. Moreover, the use of the hole transporting material as the host material allows for efficient hole transport in the light emitting layer. This decreases the electrons passing through the light emitting layer without recombining with holes to reach the layer on the hole injecting electrode side. As a result, the layer on the hole injecting electrode side can be prevented from deterioration due to electrons, enabling a longer luminescent lifetime of the organic electroluminescent device.

The light emitting layer may include one or a plurality of layers. In this case, by selecting a material or materials for the one or plurality of layers, emission in a desired color can be obtained.

The light emitting layer may include a short-wavelength light emitting layer and a long-wavelength light emitting layer, wherein at least one of peak wavelengths produced by the short-wavelength light emitting layer is smaller than 500 nm, and at least one of peak wavelengths produced by the long-wavelength light emitting layer is greater than 500 nm. In this case, the location of the hole-electron recombination region can be controlled by adjusting the thickness of the electron restricting layer. This allows for adjusting an emission ratio between the short-wavelength light emitting layer and the long-wavelength light emitting layer, resulting in emission in a desired color.

The organic electroluminescent device may include, between the hole injecting electrode and the light emitting layer, a hole transporting layer that encourages transport of holes. This allows for efficient transport of holes to the light emitting layer, resulting in improved luminous efficiency of the organic electroluminescent device.

The light emitting layer may include a host material that is a same organic compound as the hole transporting layer. This results in a smaller barrier for injection of holes to the light emitting layer, allowing for more efficient injection of holes to the light emitting layer.

The hole transporting layer may include an arylamine derivative. This improves the hole transport capability of the hole transporting layer, allowing for still more efficient injection of holes to the light emitting layer.

The hole transporting layer may include N,N′-Di(1-naphthyl)-N,N′-diphenyl-benzidine represented by the formula (10):

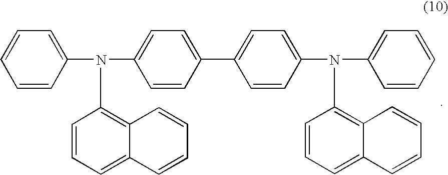

This improves the hole transport capability of the hole transporting layer, allowing for still more efficient injection of holes to the light emitting layer.

The organic electroluminescent device according to the present invention offers a lower drive voltage and extended lifetime by including the electron transporting layer that encourages electron transport and the electron restricting layer that restricts electron transfer. Furthermore, the organic electroluminescent device is capable of emission in a desired color by including the short-wavelength light emitting layer and long-wavelength light emitting layer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross section showing an example of an organic EL device according to a first embodiment;

FIG. 2 is a schematic cross section showing an example of an organic EL device according to a second embodiment;

FIG. 3 is a schematic cross section showing an example of an organic EL display apparatus using organic EL devices according to the first embodiment;

FIG. 4 is a cross-section of the organic EL display apparatus of FIG. 3 along the line A-A; and

FIG. 5 is a graph showing the luminous characteristics of organic EL devices in Inventive Example 2, Inventive Example 3, and Comparative Example 3.

### DESCRIPTION OF THE PREFERRED EMBODIMENTS

### First Embodiment

FIG. 1 is a schematic cross section showing an organic EL device according to a first embodiment of the present invention.

In fabricating the organic EL device 100 shown in FIG. 1, a hole injecting electrode 2 made of a transparent conductive film such as indium-tin oxide (ITO), for example, is formed first on a substrate 1. Then, on the hole injecting electrode 2, a hole injecting layer 3a, hole transporting layer 4, light emitting layer 5, electron restricting layer 6, and electron transporting layer 7 are formed in sequence. Further, on the electron transporting layer 7, an electron injecting electrode 8 made of aluminum or the like is formed.

The substrate 1 is a transparent substrate made of glass, plastic or the like.

The hole injecting layer 3a is made of CFx (carbon fluoride) produced by plasma CVD (plasma chemical vapor deposition) method, for example. The hole injecting layer 3a preferably has a thickness not less than 0.5 nm and not more than 5 nm. This allows for efficient injection of holes to the light emitting layer 5, inhibiting an increase in the drive voltage of the organic EL device 100.

Note that an additional hole injecting layer 3b made of CuPc (cooper phthalocyanine), for example, may be provided between the hole injecting electrode 2 and the hole injecting layer 3a. This allows for more efficient injection of holes to the light emitting layer 5.

The hole transporting layer 4 is made of an organic material such as N,N′-Di (1-naphthyl)-N,N′-diphenyl-benzidine (hereinafter abbreviated to NPB), for example, represented by the formula (10) below:

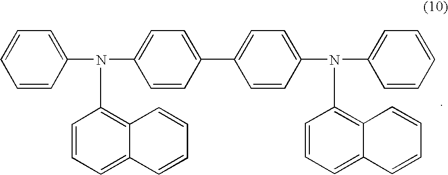

The light emitting layer 5 includes, for example, tert-butyl substituted dinaphthylanthracene (hereinafter abbreviated to BADN) represented by the formula (4) below as a host material, and 1,4,7,10-Tetra-tert-butylPerylene (hereinafter abbreviated to TBP) represented by the formula (9) below as a luminescent dopant.

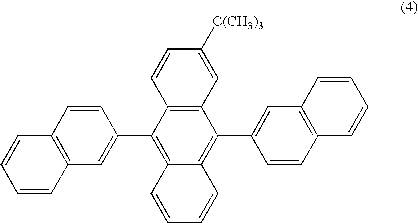

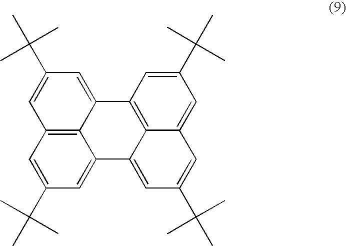

The electron restricting layer 6 is preferably made of a material having a low electron mobility or a material having a low LUMO (lowest unoccupied molecular orbital) energy level. In this embodiment, a material having a lower electron mobility than that of the electron transporting layer 7 or a material having a low LUMO (lowest unoccupied molecular orbital) energy level is selected as the material for the electron restricting layer 6. For example, an organic compound may be used having a structure represented by the formula (1) below: 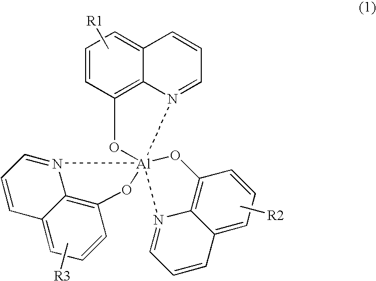
wherein R1, R2 and R3 may be the same or different from one another, and may each be in any position of a quinoline ring in the formula 1. R1, R2 and R3 in the formula (1) each represent a hydrogen atom, halogen atom or alkyl group with a carbon number not more than four.

In this embodiment, the electron restricting layer 6 is made of Tris(8-hydroxyquinolinato)aluminum (hereinafter abbreviated to Alq₃) represented by the formula (2) below. Alq₃ has an electron mobility of 10⁻⁶ cm²/Vs and a LUMO energy level of about −3.0 eV.

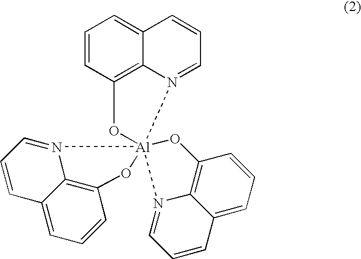

Alternatively, the electron restricting layer 6 may be made of an organic compound having a structure represented by the formula (3) below: 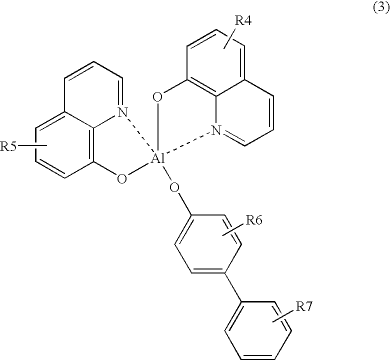
wherein R4, R5, R6 and R7 may be the same or different from one another, and may each be in any position of a benzene ring or a quinoline ring. R4, R5, R6 and R7 in the formula (3) each represent a hydrogen atom, halogen atom or alkyl group with a carbon number of not more than four.

The electron transporting layer 7 is preferably made of a material having a high electron mobility or a material having a high LUMO (lowest unoccupied molecular orbital) energy level. In this embodiment, a material having a higher electron mobility than that of the electron restricting layer 6 or a material having a high LUMO (lowest unoccupied molecular orbital) energy leve is selected as the material for the electron transporting layer 7. For example, a phenanthroline compound may be used. 1,10-phenanthroline represented by the formula (5) below or a derivative thereof is preferable as the phenanthroline compound for use as the material of the electron transporting layer 7.

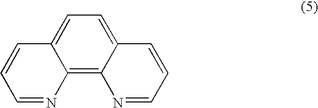

As a derivative of 1,10-phenanthroline for use as the material of the electron transporting layer 7, it is more preferable to use, for example, a compound having a structure represented by the formula (6) below: 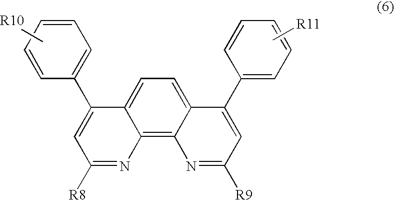
wherein R8, R9, R10 and R11 may be the same or different from one another. R8, R9, R10 and R11 in the formula (6) each represent a hydrogen atom, halogen atom, aliphatic substituent or aromatic substituent, while R10 and R11 may each be in any position of the ortho-, meta-, and para-positions of a benzene ring of the formula (6). Examples of aliphatic substituents for R8 to R11 of the formula (6) include: methyl groups, ethyl groups, 1-propyl groups, 2-propyl groups, tert-butyl groups, and the like. Examples of aromatic substituents include: phenyl groups, 1-naphthylgroups, 2-naphtylgroups, 9-anthrylgroups, 2-thenyl groups, 2-pyridyl groups, 3-pyridyl groups, and the like.

In this embodiment, the electron transporting layer 7 is made of 2,9-Dimethyl-4,7-diphenyl-1,10-phenanthroline (hereinafter abbreviated to BCP) represented by the formula (7) below. BCP has a LUMO energy level of about −2.7 eV.

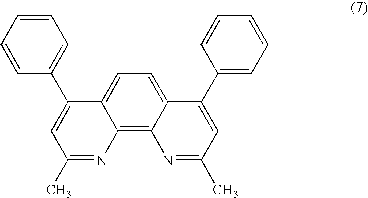

Alternatively, the electron transporting layer 7 may be made of a silole derivative represented by the formula (8) below: 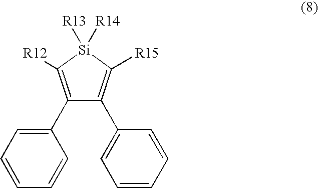
wherein R12, R13, R14 and R15 may be the same or different from one another. R12, R13, R14 and R15 in the formula (8) each represent a hydrogen atom, halogen atom, aliphatic substituent or aromatic substituent. Examples of aliphatic substituents for R12 to R15 of the formula (8) include: methyl groups, ethyl groups, 1-propyl groups, 2-propyl groups, tert-butyl groups, and the like. Examples of aromatic substituents include: phenyl groups, 1-naphthyl groups, 2-naphtyl groups, 9-anthryl groups, 2-thenyl groups, 2-pyridyl groups, 3-pyridyl groups, 2-(2-phenyl)pyridyl groups, 2,2-bipyridine-6-yl groups, and the like.

When voltage is applied between the hole injecting electrode 2 and the electron injecting electrode 8 in the above-described organic EL device 100, the light emitting layer 5 in the organic EL device 100 produces light, which is emitted through the rear surface of the substrate 1.

In the organic EL device 100 of this embodiment, BCP having a high electron mobility is used as the electron transporting layer 7. This allows for efficient injection of electrons to the light emitting layer 5. As a result, the drive voltage of the organic EL device 100 is decreased, resulting in reduced power consumption.

Moreover, between the light emitting layer 5 and the electron transporting layer 7, the electron restricting layer 6 of Alq₃ having an electron mobility lower than that of the electron transporting layer 7 and a low LUMO (lowest unoccupied molecular orbital) energy level is provided. The presence of the electron restricting layer 6 restricts transfer of electrons from the electron transporting layer 7 passing through the electron restricting layer 6 and injected to the light emitting layer 5, causing the hole-electron recombination region to shift toward the electron injecting electrode 8. This decreases the electrons passing through the light emitting layer 5 without recombining with holes to reach the hole transporting layer 4. As a result, the hole transporting layer 4 can be prevented from deterioration due to electrons, enabling a longer luminescent lifetime of the organic EL device 100.

Although in this case, current is restricted by the electron restricting layer 6, because of the high electron mobility of the electron transporting layer 7, the current flowing in the whole of the organic EL device is hardly decreased. In this manner, the combination of the electron transporting layer 7 having a high electron mobility and the electron restricting layer 6 having a low electron mobility allows the drive voltage to be maintained low while realizing a longer lifetime of the organic EL device 100.

Note that the electron transporting layer 7 has an electron mobility preferably not less than 10⁻⁵ cm²/Vs, more preferably not less than 10⁻⁴ cm²/Vs. In this case, the amount of electrons injected to the light emitting layer 5 can be sufficiently increased, resulting in a substantial decrease in the drive voltage.

Note also that the electron restricting layer 6 preferably has an electron mobility not more than one-tenth that of the electron transporting layer 7. In this case, the amount of electrons injected to the light emitting layer 5 can be sufficiently restricted, resulting in a substantially extended luminescent lifetime of the organic EL device 100.

Note also that the thickness of the electron restricting layer 6 is preferably not more than 20 nm, more preferably not more than 10 nm, still more preferably 5 nm. In this case, the amount of injected electrons can be sufficiently increased, resulting in a substantial decrease in the drive voltage.

As described above, the organic EL device 100 according to this embodiment offers a lower drive voltage and a longer luminescent lifetime by having the electron restricting layer 6 and electron transporting layer 7 formed on the light emitting layer 5.

In the organic EL device 100 according to this embodiment, the electron restricting layer 6 and electron transporting layer 7 are formed in sequence on the light emitting layer 5; however, the electron transporting layer 7 and electron restricting layer 6 may be formed in sequence on the light emitting layer 5.

Instead of the electron restricting layer 6 and electron transporting layer 7, an electron restricting/transporting layer 67 made of a mixture of the materials of the electron restricting layer 6 and electron transporting layer 7 may be formed on the light emitting layer 5. In this case, the electron restricting/transporting layer 67 contains preferably not more than 40 wt % of the material of the electron restricting layer 6, more preferably not more than 30 wt % of the material. This means that the electron restricting/transporting layer 67 contains preferably not less than 60 wt % of the material of the electron transporting layer 7, more preferably not less than 70 wt % of the material. This results in a lower drive voltage and a longer luminescent lifetime without decreasing the luminous efficiency.

Note that the material of the electron restricting layer 6 may include other organic materials having a lower electron mobility than that of the electron transporting layer 7 or other organic materials having a low LUMO (lowest unoccupied molecular orbital) energy level, without limited to the above-mentioned materials. For example, an anthracene derivative may be used. TBADN is preferable as an anthracene derivative used for the material of the electron restricting layer 6 in this embodiment.

Note also that the material of the electron transporting layer 7 may include other organic materials having a higher electron mobility than that of the electron restricting layer 6 or other organic materials having a high LUMO (lowest unoccupied molecular orbital) energy level, without limited to the above-mentioned materials.

While the light emitting layer 5 in the above-described embodiment emits in blue, the light emitting layer 5 may be made to emit in orange, green, or red.

In the case of orange emission, the light emitting layer 5 includes, for example, NPB as a host material and 5,12-Bis(4-(6-methylbenzothiazol-2-yl)phenyl)-6,11-diphenylnaphthacene (hereinafter abbreviated to DBzR) represented by the formula (12) below as a luminescent dopant.

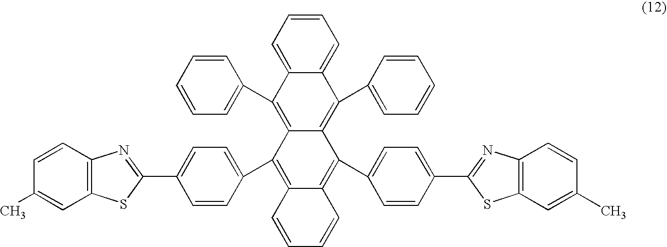

In this case, the hole transporting layer 4 and the host material of the light emitting layer 5 are the same materials, resulting in a smaller barrier for injection of holes to the light emitting layer 5. This allows for more efficient injection of holes to the light emitting layer 5.

Note also that since NPB, the same material as that of the hole transporting layer 4, is used as the host material, the light emitting layer 5 also plays the role of transporting holes. This provides efficient hole transport, resulting in improved luminous efficiency of the organic EL device 100. Moreover, the hole-electron recombination region is shifted toward the electron restricting layer 6, which reduces the electrons reaching the hole transporting layer 4 without recombining with holes. This prevents deterioration of the hole transporting layer 4, enabling a longer lifetime of the organic EL device 100.

In the case of green emission, the light emission layer 5 includes TBADN as a host material and 5,12-Bis(4-tert-butylphenyl)-naphthacene (hereinafter abbreviated to tBuDPN) represented by the formula (11) below or 3-(2-Benzothiazolyl)-7-(diethylamino)coumarin (hereinafter abbreviated to coumarin 6) represented by the formula (13) below as a luminescent dopant.

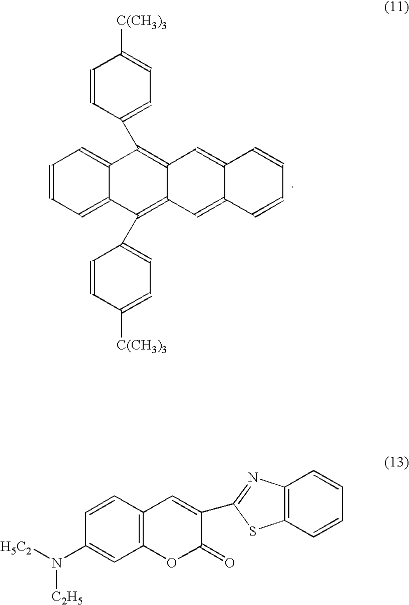

In the case of red emission, the light emitting layer 5 includes, for example, Alq₃ as a host material; rubrene represented by the formula (14) below as an auxiliary dopant; and 2-(1-1-Dimethylethyl)-6-(2-(2,3,6,7-tetrahydro-1,1,7,7-tet ramethyl-1II,5II-benzo[ij]quinolizin-9-yl)ethenyl)-4H-pyra n-4-ylidene)propanedinitrile (hereinafter abbreviated to DCJTB) represented by the formula (15) below as a luminescent dopant. In this case, the luminescent dopant emits light, and the auxiliary dopant plays the role of assisting in the emission of the luminescent dopant by encouraging transfer of energy from the host material to the luminescent dopant. The auxiliary dopant may not necessarily be doped.

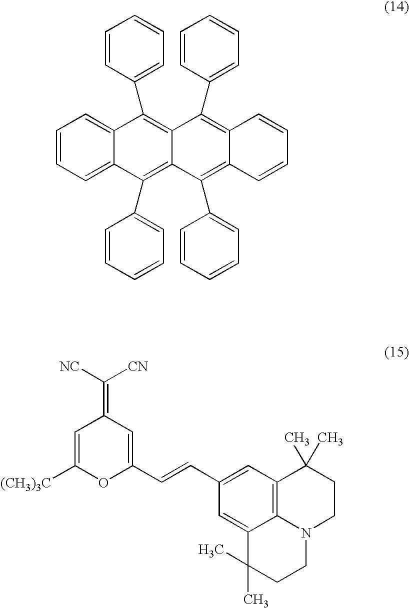

Note that the light emitting layer 5 may alternatively be made of a material whose triplet excitation energy can be converted to emission (hereinafter referred to as a triplet luminescent material). This results in improved luminous efficiency of the organic EL device 100.

### Second Embodiment

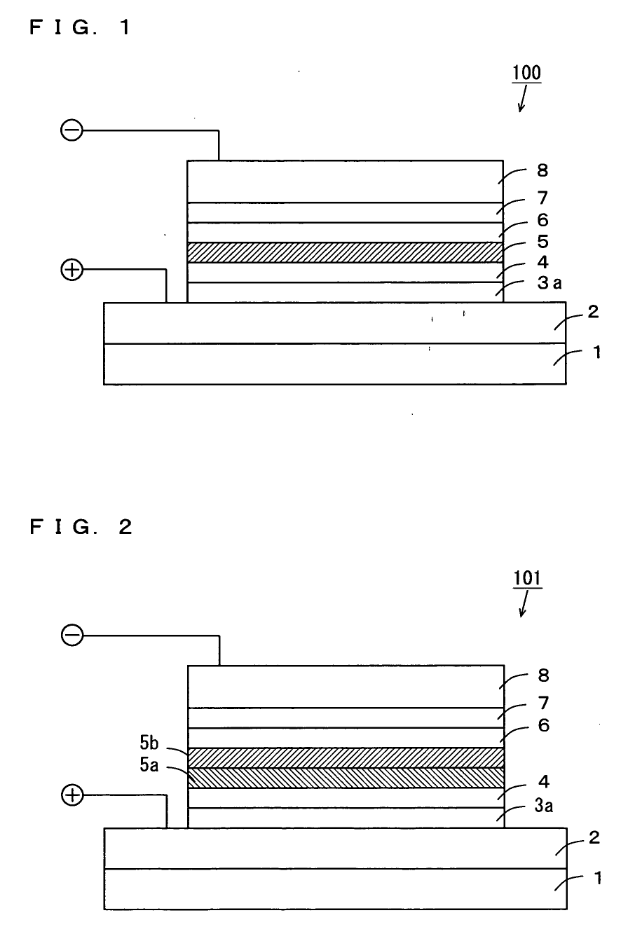

FIG. 2 is a schematic cross section showing an organic EL device according to a second embodiment of the present invention. The organic EL device 101 of the second embodiment has a structure similar to that of the organic EL device 100 of the first embodiment, except including an orange light emitting layer 5a capable of emitting orange light and a blue light emitting layer 5b capable of emitting blue light, instead of the light emitting layer 5 in the organic EL device 100 of FIG. 1.

The orange light emitting layer 5a includes, for example, NPB as a host material, tBuDPN as an auxiliary dopant, and DBzR as a luminescent dopant. In this case, the luminescent dopant emits light, and the auxiliary dopant plays the role of assisting in the emission of the luminescent dopant by encouraging transfer of energy from the host material to the luminescent dopant. This allows the orange light emitting layer 5a to produce an orange emission having a peak wavelength of greater than 500 nm and smaller than 650 nm.

In this case, the hole transporting layer 4 and the host material of the orange light emitting layer 5a are the same materials, resulting in a smaller barrier for injection of holes to the orange light emitting layer 5a. This allows for more efficient injection of holes to the orange light emitting layer 5a.

Moreover, since NPB, the same material as that of the hole transporting layer 4, is used as the host material, the orange light emitting layer 5a also has the role of transporting holes to the blue light emitting layer 5b. This allows for efficient transport of holes to the blue light emitting layer 5b, resulting in improved luminous efficiency of the organic EL device 101. In addition, the hole-electron recombination region is shifted toward the blue light emitting layer 5b, which reduces the electrons reaching the hole transporting layer 4 without recombining with holes. This prevents deterioration of the hole transporting layer 4, enabling a longer lifetime of the organic EL device 101.

The blue light emitting layer 5b includes, for example, TBADN as a host material, NPB as an auxiliary dopant, and TBP as a luminescent dopant. In this case, the luminescent dopant emits light, and the auxiliary dopant plays the role of assisting in the emission of the luminescent dopant by encouraging carrier transport. This allows the blue light emitting layer 5b to produce a blue emission having a peak wavelength of greater than 400 nm and smaller than 500 nm.

Note that the auxiliary dopants for the orange light emitting layer 5a and blue light emitting layer 5b may not necessarily be doped.

In the organic EL device 101 of this embodiment, BCP having a high electron mobility is used for the electron transporting layer 7. This allows for efficient injection of electrons to the orange light emitting layer 5a and blue light emitting layer 5b. As a result, the drive voltage of the organic EL device 101 is decreased, resulting in reduced power consumption.

Moreover, between the blue light emitting layer 5b and the electron transporting layer 7, the electron restricting layer 6 made of Alq₃ having an electron mobility lower than that of the electron transporting layer 7 and a low LUMO (lowest unoccupied molecular orbital) energy level is provided. The presence of the electron restricting layer 6 restricts transfer of electrons injected to the orange light emitting layer 5a and blue light emitting layer 5b, causing the hole-electron recombination region to shift toward the electron injecting electrode 8. In this case, the location of the hole-electron recombination region can be controlled by adjusting the thickness of the electron restricting layer 6. As a result, an emission ratio between the orange light emitting layer 5a and blue light emitting layer 5b can be adjusted, enabling emission in a desired color.

Although in this case, current is restricted by the electron restricting layer 6, because of the high electron mobility of the electron transporting layer 7, the current flowing in the whole of the organic EL device 101 is hardly reduced. In this manner, the combination of the high electron mobility electron transporting layer 7 and low electron mobility electron restricting layer 6 enables a lower drive voltage while realizing emission in a desired color.

Note that the electron transporting layer 7 has an electron mobility preferably not less than 10⁻⁵ cm²/Vs, more preferably not less than 10⁻⁴ cm²/Vs. In this case, the amount of electrons injected to the orange light emitting layer 5a and blue light emitting layer 5b can be sufficiently increased, resulting in a substantial decrease in the drive voltage.

Note also that the electron restricting layer 6 preferably has an electron mobility not more than one-tenth that of the electron transporting layer 7. In this case, the amount of electrons injected to the orange light emitting layer 5a and blue light emitting layer 5b can be sufficiently restricted, thus easily enabling emission in a desired color.

Note also that the electron restricting layer 6 has a thickness preferably not more than 20 nm, more preferably not more than 10 nm, still preferably 5 nm. In this case, the amount of injected electrons can be sufficiently increased, resulting in a substantial decrease in the drive voltage.

As described above, the organic EL device 101 according to this embodiment offers a lower drive voltage as well as emission in a desired color by having the electron restricting layer 6 and electron transporting layer 7 formed on the blue light emitting layer 5b.

Furthermore, when the orange light emitting layer 5a and blue light emitting layer 5b produce lights, white light can be obtained. In this case, when an organic EL device capable of emitting white light is provided with red, green, and blue filters, a display of three primary colors of light (RGB display) is enabled, leading to a full-color display.

In the organic EL device 101 according to this embodiment, the electron restricting layer 6 and electron transporting layer 7 are formed in sequence on the blue light emitting layer 5b; however, the electron transporting layer 7 and electron restricting layer 6 may be formed on the blue light emitting layer 5b, in sequence. Instead of the electron restricting layer 6 and electron transporting layer 7, a layer made of a mixture of the materials of the electron restricting layer 6 and electron transporting layer 7 may be formed on the blue light emitting layer 5b.

Alternatively, the orange light emitting layer Sa may include, for example, 4,4′-Bis(carbazol-9-yl)biphenyl (hereinafter abbreviated to CBP) represented by the formula (16) below as a host material and Tris(2-phenylquinoline)iridium (hereinafter abbreviated to Ir(phq)₃) represented by the formula (17) below as a luminescent dopant. In this case, since Ir(phq)₃ is a triplet luminescent material, the luminous efficiency of the organic EL device 101 can be improved.

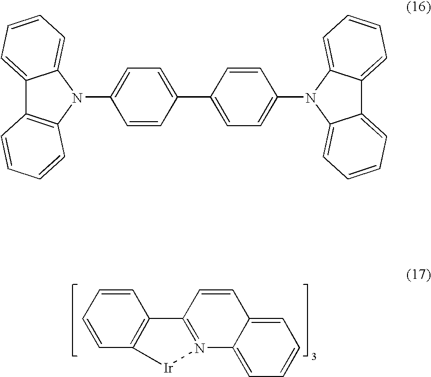

In this embodiment, the orange light emitting layer 5a corresponds to a long-wavelength light emitting layer, and the blue light emitting layer 5b corresponds to a short-wavelength light emitting layer.

### Third Embodiment

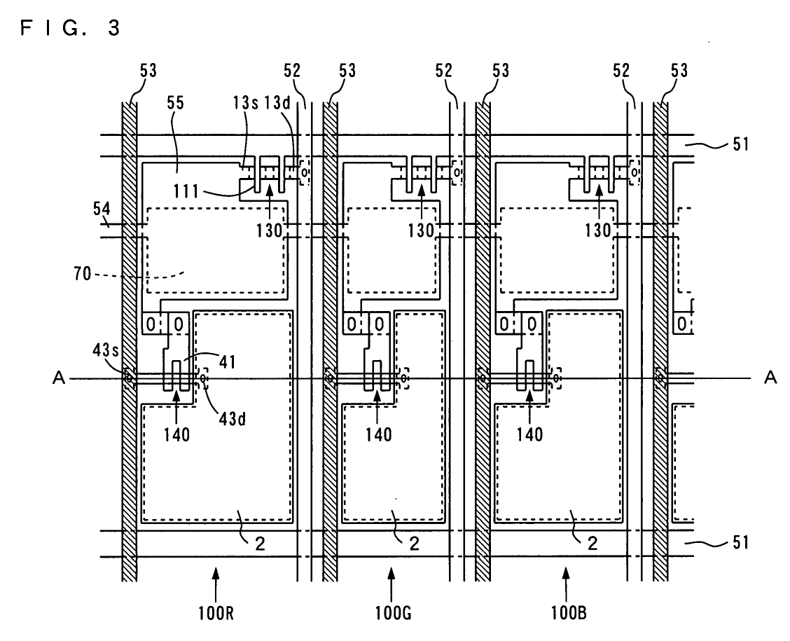

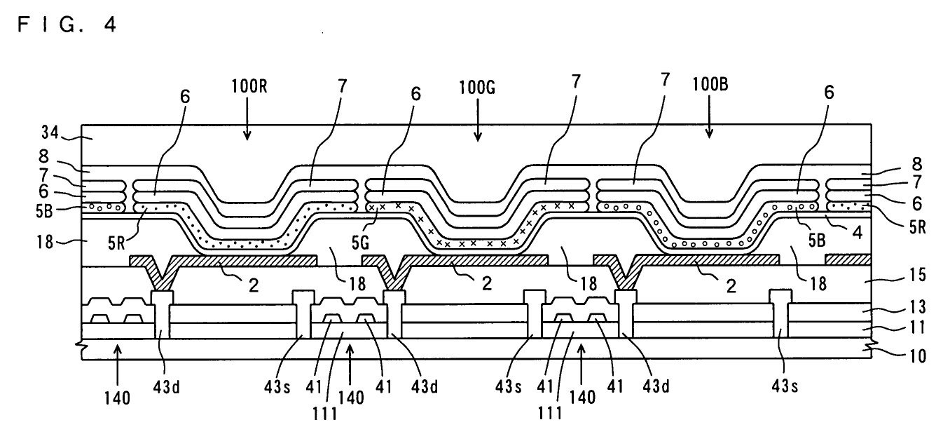

FIG. 3 is a schematic plan view showing an example of an organic EL display apparatus using organic EL devices, and FIG. 4 is a cross section of the organic EL display apparatus of FIG. 3 along the line A-A.

In the organic EL display apparatus of FIG. 3 and FIG. 4, an organic EL device 100R that emits in red, an organic EL device 100G that emits in green, and an organic EL device 100B that emits in blue are arranged in the matrix form.

Each of the organic EL devices 100R, 100G, 100B has a similar structure to that of the organic EL device 100 in FIG. 1. Each of the organic EL devices 100R, 100G, 100B comprises a red light emitting layer 5R that emits in red, a green light emitting layer 5G that emits in green, and a blue light emitting layer 5B that emits in blue, respectively, as a light emitting layer 5. The materials described in the first embodiment may be used for the light emitting layers 5R, 5G, 5B, respectively.

The organic EL display apparatus according to this embodiment will be described in more detail below.

In FIG. 3, the organic EL device 100R, organic EL device 100G, and organic EL device 100B are shown in sequence from the left.

The organic EL devices 100R, 100G, 100B are shown to have the same structure on the plan view. Each of the organic EL devices 100R, 100G, 100B is formed in a region surrounded with two gate signal lines 51 extending in the row direction and two of drain signal lines (data lines) 52 extending in the column direction. In the region of each of the organic EL devices, a first TFT 130 or a switching device is formed around an intersection of a gate signal line 51 and drain signal line 52, and a second TFT 140 for driving each of the organic EL device 100R, 100G, and 100B is formed around the center. In the region of each of the organic EL devices 100R, 100G, 100B, an auxiliary capacitor 70 and a hole injecting electrode 2 made of ITO are also formed. The organic EL devices 100R, 100G, 100B are formed, respectively, like islands on the corresponding hole injecting electrodes 2.

The drain of the first TFT 130 is connected to the drain signal line 52 via a drain electrode 13d, and the source of the first TFT 130 is connected to an electrode 55 via a source electrode 13s. Agate electrode 111 of the first TFT 130 extends from the gate signal line 51.

The auxiliary capacitor 70 is composed of a SC line 54 receiving a power supply voltage Vsc and the electrode 55 integral with an activation layer 11 (see FIG. 4).

The drain of the second TFT 140 is connected via a drain electrode 43d to the hole injecting electrode 2 in each of the organic EL devices, and the source of the second TFT 140 is connected via a source electrode 43s to a power supply line 53 extending in the column direction. A gate electrode 41 of the second TFT 140 is connected to the electrode 55.

As shown in FIG. 4, the activation layer 11 made of polycrystalline silicon or the like is formed on a glass substrate 10, and a portion of the activation layer 11 serves as the second TFT 140 for driving each of the organic EL devices. The gate electrode 41 with a double-gate structure is formed on the activation layer 11 through a gate oxide film (not shown), and so as to cover the gate electrode 41, an interlayer insulating film 13 and a first planarization layer 15 are formed on the activation layer 11. An acrylic resin, for example, may be used as the material for the first planarization layer 15. The transparent hole injecting electrode 2 is formed on the first planarization layer 15 for each of the organic EL devices, and so as to cover the hole injecting electrode 2, an insulative second planarization layer 18 is formed on the first planarization layer 15. The second TFT 140 is formed below the second planarization layer 18.

A hole transporting layer 4 is formed over the entire region so as to cover the hole injecting electrode 2 and second planarization layer 18.

The red light emitting layer 5R, green light emitting layer 5G, and blue light emitting layer 5B, each in the stripe form, are formed, respectively, on the hole transporting layers 4 of the organic EL device 100R, organic EL device 100G, and organic EL device 100B, such that they extend in the column direction.

Boundaries between the red light emitting layer 5R, green light emitting layer 5G, and blue light emitting layer 5B in the stripe form are provided on surfaces in parallel with the glass substrate 10 above the corresponding second planarization layers 18.

On each of the red light emitting layer 5R in the organic EL device 100R, green light emitting layer 5G in the organic EL device 100G, and blue light emitting layer 5B in the organic EL device 100B, the electron restricting layer 6 and electron transporting layer 7 in the stripe form are formed, respectively, such that they extend in the column direction.

The electron restricting layer 6 is made of Alq₃ having a low electron mobility, for example, as in the first and second embodiments. The electron transporting layer 7 is made of BCP having a high electron mobility, for example, as in the first and second embodiments.

An electron injecting electrode 8 is further formed on each of the electron transporting layers 7. On the electron injecting electrode 8, a protective film 34 made of a resin or the like is formed.

In the above-described organic EL display apparatus, when a selection signal is output to a gate signal line 51, a corresponding first TFT 130 is turned on, causing the auxiliary capacitor 70 to be charged in response to the value of a voltage (data signal) which is applied at that moment to the drain signal line 52. The gate electrode 41 of the second TFT 140 receives a voltage corresponding to an electric charge charged in the auxiliary capacitor 70. This controls the current supplied to each of the organic EL devices 100R, 100G, 100B from the power supply line 53, causing each of the organic EL devices 100R, 100G, 100B to emit light at a luminance corresponding to the current supplied.

In each of the organic EL devices 100R, 100G, 100B in the organic EL display apparatus of this embodiment, BCP having a high electron mobility is used for the electron transporting layer 7. This allows for efficient injection of electrons to the red light emitting layer 5R, green light emitting layer 5G, and blue light emitting layer 5B. As a result, the drive voltage of each of the organic EL devices 100R, 100G, 100B is decreased, resulting in reduced power consumption of the organic EL display apparatus.

In addition, between each of the red light emitting layer 5R, green light emitting layer 5G, and blue light emitting layer 5B and the electron transporting layer 7, the electron restricting layer 6 made of Alq₃ having an electron mobility lower than that of the electron transporting layer 7 is provided. The presence of the electron restricting layer 6 restricts transfer of electrons from the electron transporting layer 7 passing through the electron restricting layer 6 and injected to each of the red light emitting layer 5R, green light emitting layer 5G, and blue light emitting layer 5B, causing the hole-electron recombination region to shift toward the electron injecting electrode 8. This decreases the electrons reaching the hole transporting layer 4 without recombining with holes. As a result, the hole transporting layer 4 can be prevented from deterioration due to electrons, enabling a longer luminescent lifetime of each of the red light emitting layer 5R, green light emitting layer 5G and blue light emitting layer 5B.

Although in this case, current is restricted by the electron restricting layer 6, because of the high electron mobility of the electron transporting layer 7, the current flowing in each of the organic EL devices 100R, 100G, 100B is hardly reduced. In this manner, the recombination of the high electron mobility electron transporting layer 7 and low electron mobility electron restricting layer 6 allows the drive voltage to be maintained low while realizing a longer lifetime of each of the red light emitting layer 5R, green light emitting layer 5G, and blue light emitting layer 5B. This results in a full-color display with a lower power consumption and longer luminescent lifetime.

### Other Embodiments

The host material for the light emitting layer 5 is not limited to those in the aforementioned embodiments. Examples of the host material for the light emitting layer 5 may include: a metal-chelated oxinoid compound such as tris(8-hydroxyquinolinato)aluminum, diarylbutadiene derivative, stilbene derivative, benzoxazole derivative, benzothiazole derivative, CBP, triazole-based compound, imidazole-based compound, oxadiazole-based compound, fused ring derivative such as anthracene derivative, pyrene derivative, perylene derivative or the like, heterocycle derivative such as pyrazine derivative, naphthylidine derivative, quinoxaline derivative, pyrrolopyridine derivative, pyrimidine derivative, thiophene derivative, thioxanthen derivative or the like, benzoquinolinol metal complex, bipyridine metal complex, rhodamine metal complex, azomethine metal complex, distyrylbenzene derivative, tetraphenylbutadiene derivative, stilbene derivative, aldazine derivative, coumarin derivative, phthalimide derivative, naphtalimide derivative, perinone derivative, pyrrolopyrrole derivative, cyclopentadiene derivative, azole derivative such as imidazole derivative, oxazole derivative, thiazole derivative, oxadiazole derivative, thiadiazole derivative, triazole derivative or the like and a metal complex thereof, benzazole derivative such as benzoxazole derivative, benzimidazole derivative, benzothiazole derivative or the like and a metal complex thereof, amine derivative such as triphenylamine derivative, carbazol derivative or the like, phosphorescent material such as merocyanin derivative, porphyrin derivative, tris (2-phenylpyridine) iridium complex, or the like, polyphenylenevinylene derivative, polyparaphenylene derivative, polythiophene derivative or the like.

Examples of the luminescent dopant for the light emitting layer 5 may include: a fused polycyclic aromatic hydrocarbon such as anthracene, perylene or the like, coumarin derivative such as 7-dimethylamino-4-methylcoumarin, naphtalimide derivative such as bis(diisopropylphenyl)perylenetetra carboxylic imide derivative or the like, perinone derivative, rare-earth metal complex such as Eu complex containing acetyl acetone, benzoylacetone, phenanthroline or the like as a ligand, dicyanomethylenepyran derivative, dicyanomethylenethiopyran derivative, metal phthalocyanine derivative such as magnesium phthalocyanine, aluminum chlorophthalocyanine or the like, porphyrin derivative, rhodamine derivative, deazaflavin derivative, coumarin derivative, oxazine compound, thioxanthen derivative, cyanine dye derivative, fluorescein derivative, acridine derivative, quinacridone derivative, pyrrolopyrrole derivative, quinazoline derivative, pyrrolopyridine derivative, squarylium derivative, violanthrone derivative, phenazine derivative, acridone derivative, deazaflavin derivative or pyrromethene derivative and a metal complex thereof, phenoxazine derivative, phenoxazone derivative, thiadiazolopyrene derivative, tris(2-phenylpyridine)iridium complex, tris(2-phenylpyridyl)iridium complex, tris[2-(2-thiophenyl)pyridyl]iridium complex, tris[2-(2-benzothiophenyl)pyridyl]indium complex, tris(2-phenylbenzothiazole) iridium complex, tris(2-phenylbenzoxazole)iridium complex, trisbenzoquinolineiridium complex, bis(2-phenylpyridyl)(acetylacetonate) iridium complex, bis[2-(2-thiophenyl)pyridyl]iridium complex, bis[2-(2-benzothiophenyl)pyridyl](acetylacetonate) iridium complex, bis(2-phenylbenzothiazole) (acetylacetonate)iridium complex or the like.

### EXAMPLES

Organic EL devices were fabricated in Inventive Examples and Comparative Examples below. Each of the organic EL devices fabricated was measured for luminous characteristics.

### Comparisons Between Inventive Example 1 and Comparative Examples 1, 2

### Inventive Example 1

In Inventive Example 1, an organic EL device with the structure of FIG. 1 that emits in blue was fabricated as follows.

A hole injecting electrode 2 made of indium-tin oxide (ITO) was formed on a substrate 1 made of glass. Then, a hole injecting layer 3a made of CFx (carbon fluoride) was formed on the hole injecting electrode 2 by plasma CVD method. Plasma discharge by plasma CVD was performed for 15 sec.

Then, on the hole injecting layer 3a, a hole transporting layer 4, light emitting layer 5, electron restricting layer 6, and electron transporting layer 7 were formed in sequence by vacuum deposition.

The hole transporting layer 4 was made of NPB with a thickness of 150 nm. The light emitting layer 5 with a thickness of 30 nm was formed by doping TBADN as a host material with 1 wt % TBP as a luminescent dopant. The electron restricting layer 6 was made of Alq₃ with a thickness of 3 nm. The electron transporting layer 7 was made of BCP with a thickness of 7 nm.

After this, an electron injecting electrode 8 with a laminated structure of a 1-nm-thick lithium fluoride film and a 200-nm-thick aluminum film was formed on the electron transporting layer 7.

The organic EL device thus fabricated was measured at 10 MA/cm² for drive voltage, CIE chromaticity coordinates, luminous efficiency, and luminescent lifetime. The luminescent lifetime as used in Inventive Example 1 and Comparative Examples 1, 2 below refers to the time it took for a luminance of 3000 cd/m² at the initial measurement to decrease to half.

The result was that the organic EL device of Inventive Example 1 had a drive voltage of 4.2 V; CIE chromaticity coordinates (x, y)=(0.14, 0.13); a luminous efficiency of 5.8 cd/A; and a luminescent lifetime of 130 hr.

### Comparative Example 1

In Comparative Example 1, an organic EL device with the same structure as that of Inventive Example 1 was fabricated, except that the electron restricting layer 6 was 10 nm thick, and an electron transporting layer 7 was not formed.

The organic EL device of Comparative Example 1 was measured at 10 mA/cm² for drive voltage, CIE chromaticity coordinates, luminous efficiency, and luminescent lifetime.

The result was that the organic EL device of Comparative Example 1 had a drive voltage of 6.2 V; CIE chromaticity coordinates (x, y)=(0.14, 0.14); a luminous efficiency of 4.0 cd/A; and a luminescent lifetime of 150 hr.

### Comparative Example 2

In Comparative Example 2, an organic EL device with the same structure as that of Inventive Example 1 was fabricated, except that the electron transporting layer 7 was 10 nm thick, and an electron restricting layer 6 was not formed.

The organic EL device of Comparative Example 2 was measured at 10 mA/cm² for drive voltage, CIE chromaticity coordinates, luminous efficiency, and luminescent lifetime.

The result was that the organic EL device of Comparative Example 2 had a drive voltage of 3.8 V; CIE chromaticity coordinates (x, y)=(0.14, 0.13); a luminous efficiency of 5.4 cd/A; and a luminescent lifetime of 60 hr.

(Evaluation)

Table 1 shows the conditions for each of the layers in the organic EL devices of Inventive Example 1, Comparative Example 1, and Comparative Example 2, respectively. Table 2 shows the measurements of drive voltages, CIE chromaticity coordinates, luminous efficiencies, and luminescent lifetimes for the organic EL devices of Inventive Example 1, Comparative Example 1, and Comparative Example 2, respectively.

TABLE 1

| | Hole | | Light Emitting | | | |
|---|---|---|---|---|---|---|
| | Injecting | | Layer | | | |
| | Layer | | (TBADN + TBP) | | | |
| | (CFₓ) | Hole | | Amount | Electron | Electron |
| | Plasma | Transporting | | of | Restricting | Transporting |
| | Discharge | Layer | | Doped | Layer | Layer |
| | Time | (NPB) | Thickness | TBP | (Alq3) | (BCP) |
| | [sec] | [nm] | [nm] | [%] | [nm] | [nm] |
| Inventive | 15 | 150 | 30 | 1 | 3 | 7 |
| Example 1 | | | | | | |
| Comparative | 15 | 150 | 30 | 1 | 10 | — |
| Example 1 | | | | | | |
| Comparative | 15 | 150 | 30 | 1 | — | 10 |
| Example 2 | | | | | | |

TABLE 2

| | Drive | CIE Chromaticity | Luminous | Luminescent |
|---|---|---|---|---|
| | Voltage | Coordinates | Efficiency | Lifetime |
| | [V] | [x, y] | [cd/A] | [h] |
| Inventive | 4.2 | (0.14, 0.13) | 5.8 | 130 |
| Example 1 | | | | |
| Comparative | 6.2 | (0.14, 0.14) | 4.0 | 150 |
| Example 1 | | | | |
| Comparative | 3.8 | (0.14, 0.13) | 5.4 | 60 |
| Example 2 | | | | |

As shown in Table 2, the organic EL device in Inventive Example 1 has a drive voltage lower than that of the organic EL device in Comparative Example 1.

The organic EL device in Inventive Example 1 includes the electron transporting layer 7 made of BCP having a high electron mobility between the electron restricting layer 6 and electron injecting electrode 8. It is believed that this electron transporting layer 7 encouraged transfer of electrons to decrease the drive voltage of the organic EL device in Inventive Example 1.

In contrast, the organic EL device in Comparative Example 1 does not include such an electron transporting layer 7 made of BCP having a high electron mobility, and only includes an electron restricting layer 6 made of Alq₃ having a low electron mobility. It is believed that this electron restricting layer 6 restricted transfer of electrons to increase the drive voltage in Comparative Example 1.

Note that the organic EL device in Inventive Example 1 has a luminous efficiency higher than that of the organic EL device in Comparative Example 1. In addition, the organic EL device in Inventive Example 1 has a luminescent lifetime almost equal to that of the organic EL device in Comparative Example 1. This means that the characteristics of the organic EL device in Inventive Example 1 hardly deteriorate by the provision of the electron transporting layer 7 made of BCP.

Moreover, as shown in Table 2, the organic EL device in Inventive Example 1 has a luminescent lifetime sufficiently longer than that of the organic EL device in Comparative Example 2.

The organic EL device in Inventive Example 1 includes the electron restricting layer 6 made of Alq₃ between the electron transporting layer 7 and light emitting layer 5. This electron restricting layer 6 restricts transfer of electrons injected from the electron transporting layer 7 to the light emitting layer 5. It is believed that this caused the electron-hole recombination region to shift toward the electron injecting electrode 8, so as to reduce electrons passing through the light emitting layer 5 without recombining with holes to reach the hole transporting layer 4. As a result, the hole transporting layer 4 was prevented from deterioration, enabling a longer luminescent lifetime of the organic EL device in Inventive Example 1.

In contrast, the organic EL device in Comparative Example 2 does not include an electron restricting layer 6. It is believed that for this reason, the electron-hole recombination region was located closer to the hole injecting electrode 2, resulting in an increase in the electrons passing through the light emitting layer 5 without recombining with holes to reach the hole transporting layer 4. As a result, the hole transporting layer 4 deteriorated, making the luminescent lifetime short.

Note that the organic EL device in Inventive Example 1 has a drive voltage and luminous efficiency almost equal to those of the organic EL device in Comparative Example 2. This means that the characteristics of the organic EL device in Inventive Example 1 hardly deteriorate by the provision of the electron restricting layer 6 made of Alq₃.

Furthermore, as shown in Table 2, the organic EL device in Inventive Example 1 has CIE chromaticity coordinates almost equal to those of the organic EL device in Comparative Example 1 and organic EL device in Comparative Example 2.

As described above, using a material with a low electron mobility or a material with a low LUMO (lowest unoccupied molecular orbital) energy level for the electron restricting layer 6, and using a material with a high electron mobility for the electron transporting layer 7, the organic EL device can provide a lower drive voltage and extended luminescent lifetime without deterioration in luminous characteristics.

### Comparisons Between Inventive Example 2 Through Inventive Example 5 and Comparative Example 3

### Inventive Example 2

In Inventive Example 2, an organic EL device with the structure of FIG. 2 was fabricated as follows.

A hole injecting electrode 2 made of indium-tin oxide (ITO) was formed on a substrate 1 made of glass. Then, a hole injecting layer 3a made of CFx (carbon fluoride) was formed on the hole injecting electrode 2 by plasma CVD method. Plasma discharge by plasma CVD was performed for 15 sec.

Next, a hole transporting layer 4, orange light emitting layer 5a, blue light emitting layer 5b, electron restricting layer 6, and electron transporting layer 7 were formed in sequence on the hole injecting layer 3a by vacuum deposition.

The hole transporting layer 4 is made of NPB with a thickness of 150 nm. The orange light emitting layer 5a with a thickness of 60 nm was formed by doping NPB as a host material with 10 wt % tBuDPN as a first dopant and 3 wt % DBzR as a second dopant.

The blue light emitting layer 5b with a thickness of 50 nm was formed by doping BADN as a host material with 20 wt % NPB as a first dopant and 1 wt % TBP as a second dopant.

The electron restricting layer 6 is made of Alq₃ with a thickness of 3 nm. The electron transporting layer 7 is made of BCP with a thickness of 7 nm.

After this, an electron injecting electrode 8 with a laminated structure of a 1-nm-thick lithium fluoride film and a 200-nm-thick aluminum film was formed on the electron transporting layer 7.

The organic EL device thus fabricated was measured at 10 mA/cm² for drive voltage, CIE chromaticity coordinates, and luminous efficiency.

The result was that the organic EL device in Inventive Example 2 had a drive voltage of 5.1 V; CIE chromaticity coordinates (x, y)=(0.400, 0.395); and a luminous efficiency of 15.2 cd/A.

### Inventive Example 3

In Inventive Example 3, an organic EL device similar to that of Inventive Example 2 was fabricated except that the electron restricting layer 6 was 5 nm thick.

The organic EL device in Inventive Example 3 was measured at 10 mA/cm² for drive voltage, CIE chromaticity coordinates, and luminous efficiency.

The result was that the organic EL device in Inventive Example 2 had a drive voltage of 5.5 V; CIE chromaticity coordinates (x, y)=(0.354, 0.466); and a luminous efficiency of 14.1 cd/A.

### Inventive Example 4

In Inventive Example 4, an organic EL device similar to that of Inventive Example 2 was fabricated except that TBADN was used as the material of the electron restricting layer 6.

The organic EL device in Inventive Example 4 was measured at 20 mA/cm² for drive voltage, CIE chromaticity coordinates, and luminous efficiency.

The result was that the organic EL device in Inventive Example 4 had a drive voltage of 5.2 V; CIE chromaticity coordinates (x, y)=(0.392, 0.390); and a luminous efficiency of 13.6 cd/A.

### Inventive Example 5

In Inventive Example 5, an organic EL device similar to that of Inventive Example 3 was fabricated except that TBADN was used as the material of the electron restricting layer 6.

The organic EL device in Inventive Example 5 was measured at 20 mA/cm² for drive voltage, CIE chromaticity coordinates, and luminous efficiency.

The result was that the organic EL device in Inventive Example 5 had a drive voltage of 5.7 V; CIE chromaticity coordinates (x, y)=(0.332, 0.331); and a luminous efficiency of 12.4 cd/A.

### Comparative Example 3

In Comparative Example 3, an organic EL device similar to that of Inventive Example 2 was fabricated except that an electron restricting layer 6 was not formed.

The organic EL device in Comparative Example 3 was measured at 20 mA/cm² for drive voltage, CIE chromaticity coordinates, and luminous efficiency.

The result was that the organic EL device in Comparative Example 3 had a drive voltage of 4.5 V; CIE chromaticity coordinates (x, y)=(0.464, 0.441); and a luminous efficiency of 15.6 cd/A.

(Evaluation)

Table 3 shows the conditions of each of the layers in the organic EL devices of Inventive Example 2 through Inventive Example 5 and Comparative Example 3, respectively. Table 4 shows the measurements of drive voltages, CIE chromaticity coordinates, and luminous efficiencies for the organic EL devices of Inventive Example 2 through Inventive Example 5 and Comparative Example 3, respectively.

TABLE 3

| | | Orange Light Emitting | | | Blue Light Emitting | | | | | |
|---|---|---|---|---|---|---|---|---|---|---|
| | | Layer | | | Layer | | | | | |
| | | (NPB + tBuDPN + DBzR) | | | (TBADN + NPB + TBP) | | | | | |
| | Hole | | Amount | | | Amount | Amount | Electron | | Electron |
| | Transporting | | of | Amount | | of | of | Restricting | | Transporting |
| | Layer | | Doped | of Doped | | Doped | Doped | Layer | | Layer |
| | (NPB) | Thickness | tBuDPN | DBzR | Thickness | NPB | TBP | (Alq3) | (TBADN) | (BCP) |
| | [nm] | [nm] | [%] | [%] | [nm] | [%] | [%] | [nm] | [nm] | [nm] |
| Inventive | 150 | 60 | 10 | 3 | 50 | 20 | 1 | 3 | — | 7 |
| Example 2 | | | | | | | | | | |
| Inventive | 150 | 60 | 10 | 3 | 50 | 20 | 1 | 5 | — | 7 |
| Example 3 | | | | | | | | | | |
| Inventive | 150 | 60 | 10 | 3 | 50 | 20 | 1 | — | 3 | 7 |
| Example 4 | | | | | | | | | | |
| Inventive | 150 | 60 | 10 | 3 | 50 | 20 | 1 | — | 5 | 7 |
| Example 5 | | | | | | | | | | |
| Comparative | 150 | 60 | 10 | 3 | 50 | 20 | 1 | — | — | 7 |
| Example 3 | | | | | | | | | | |

TABLE 4

| | Drive | CIE Chromaticity | Luminous |
|---|---|---|---|
| | Voltage | Coordinates | Efficiency |
| | [V] | [x, y] | [cd/A] |
| Inventive | 5.1 | (0.400, 0.395) | 15.2 |
| Example 2 | | | |
| Inventive | 5.5 | (0.354, 0.366) | 14.1 |
| Example 3 | | | |
| Inventive | 5.2 | (0.392, 0.390) | 13.6 |
| Example 4 | | | |
| Inventive | 5.7 | (0.332, 0.331) | 12.4 |
| Example 5 | | | |
| Comparative | 4.5 | (0.464, 0.441) | 15.6 |
| Example 3 | | | |

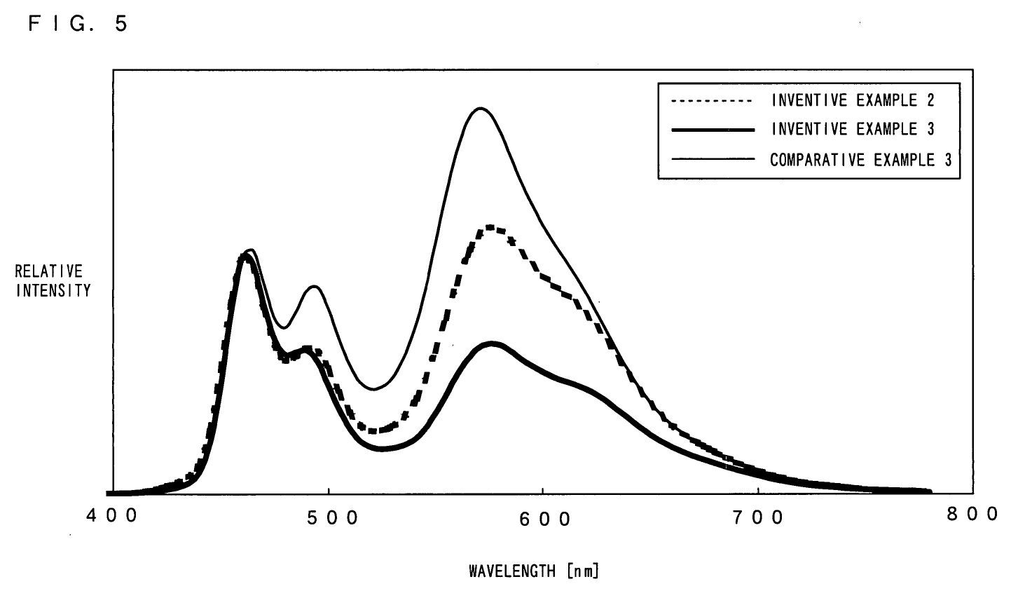

FIG. 5 is a graph showing the emission spectra of Inventive Example 2, Inventive Example 3, and Comparative Example 3. In FIG. 5, the abscissa represents wavelength, and the ordinate represents relative intensity.

As shown in FIG. 5, the emission spectrum for each of the organic EL devices in Inventive Example 2, Inventive Example 3, and Comparative Example 3 exhibits a first peak value at around 450 nm and a second peak value at around 570 nm.

For the organic EL device in Inventive Example 2, the first and second peak values are almost equal. For the organic EL device in Inventive Example 3, the first peak value is greater than the second peak value. For the organic EL device in Comparative Example 3, the second peak value is greater than the first peak value.

In this manner, the magnitude of the second peak value to the first peak value varies depending on the thickness of the electron restricting layer 6. In other words, by adjusting the thickness of the electron restricting layer 6, the luminous intensity ratio between the orange light emitting layer 5a and the blue light emitting layer 5b can be adjusted, so that desired white emission can be obtained.

In addition, as shown in Table 4, the drive voltage for each of the organic EL devices in Inventive Example 2 and Inventive Example 3 is hardly increased as compared to the drive voltage for the organic EL device in Comparative Example 3. Moreover, the organic EL devices in Inventive Example 2 and Inventive Example 3 have luminous efficiencies almost equal to that of Comparative Example 3. This means that the characteristics of the organic EL devices in Inventive Example 2 and Comparative Example 3 hardly deteriorate by the provision of the electron restricting layers 6 made of Alq₃.

As described above, using a material with a low electron mobility or a material with a low LUMO (lowest unoccupied molecular orbital) energy level for the electron restricting layer 6, and using a material with a high electron mobility for the electron transporting layer 7, the organic EL device provides a lower drive voltage and emission in a desired color without deterioration in luminous characteristics.

Furthermore, as shown in Table 4, the organic EL devices in Inventive Example 4 and Inventive Example 5 also vary in chromaticity coordinates. This demonstrates that as in the case of Alq₃ for the electron restricting layer 6, using TBADN for the electron restricting layer 6 also enables emission in a desired color by adjusting the thickness of the electron restricting layer 6.

### Comparisons Between Inventive Examples 6, 7 and Comparative Examples 4, 5

### Inventive Example 6

An organic EL device in Inventive Example 6 is different from the organic EL device in Inventive Example 1 as follows.

In Inventive Example 6, a hole transporting layer 3b made of CuPc (copper phthalocyanine) was formed between hole injecting electrode 2 and hole transporting layer 3a by vacuum deposition. The hole transporting layer 3b has a thickness of 10 nm, and the hole transporting layer 3a has a thickness of 1 nm.

A light emitting layer 5 with a thickness of 40 nm was formed by doping NPB as a host material with tBuDPN as a luminescent dopant. This light emitting layer 5 emits in green.

### Inventive Example 7

An organic EL device in Inventive Example 7 is different from the organic EL device in Inventive Example 6 as follows.

In Inventive Example 7, instead of the electron restricting layer 6 and electron transporting layer 7, an electron restricting/transporting layer 67 with a thickness of 10 nm was formed on the light emitting layer 5 by vacuum deposition. The electron restricting/transporting layer 67 was formed so as to contain 20 wt % Alq₃ for the whole of the electron restricting layer 67.

### Comparative Example 4

An organic EL device in Comparative Example 4 is different from the organic EL device in Inventive Example 6 in that an electron transporting layer 7 was not formed, and the electron restricting layer 6 was 10 nm thick.

### Comparative Example 5

An organic EL device in Comparative Example 5 is different from the organic EL device in Inventive Example 6 in that an electron restricting layer 6 is not formed, and the electron transporting layer 7 was 10 nm thick.

(Evaluation)

The organic EL devices in Inventive Examples 6, 7 as well as Comparative Examples 4, 5 were measured at 20 mA/cm² for drive voltage, CIE chromaticity coordinates, luminous efficiency, luminescent lifetime, power efficiency, and external quantum efficiency. As used herein, the luminescent lifetime refers to the time it took for a luminance of 1000 cd/m² at the initial measurement to decrease to half.

Table 5 shows the conditions of each of the layers in the organic EL devices of Inventive Examples 6, 7 as well as Comparative Examples 4, 5, respectively. Table 6 shows the measurements of drive voltages, CIE chromaticity coordinates, luminous efficiencies, luminescent lifetimes, power efficiencies, and external quantum efficiencies for the organic EL devices of Inventive Examples 6, 7 as well as Comparative Examples 4, 5, respectively.

TABLE 5

| | | | | | Electron | | | |
|---|---|---|---|---|---|---|---|---|
| | | | | | Restricting | | | |
| | Hole | | Hole | Light | Transporting Layer | | Electron | Electron |
| | Injecting | | Transporting | Emitting | (BCP + Alq3) | | Restricting | Transporting |
| | Layer | | Layer | Layer | | Alq3 | Layer | Layer |
| | CuPc | CFx | (NPB) | (NPB + tBuDPN) | Thickness | Content | (Alq3) | (BCP) |
| | [nm] | [nm] | [nm] | [nm] | [nm] | [%] | [nm] | [nm] |
| Inventive | 10 | 1 | 150 | 40 | — | — | 3 | 7 |
| Example 6 | | | | | | | | |
| Inventive | 10 | 1 | 150 | 40 | 10 | 20 | — | — |
| Example 7 | | | | | | | | |
| Comparative | 10 | 1 | 150 | 40 | — | — | 10 | — |
| Example 4 | | | | | | | | |
| Comparative | 10 | 1 | 150 | 40 | — | — | — | 10 |
| Example 5 | | | | | | | | |

TABLE 6

| | | CIE | | | | External |
|---|---|---|---|---|---|---|
| | Drive | Chromaticity | Luminous | Luminescent | Power | Quantum |
| | Voltage | Coordinates | Efficiency | Lifetime | Efficiency | Efficiency |
| | [V] | [x, y] | [cd/A] | [h] | [Lm/W] | [%] |
| Inventive | 4.62 | (0.27, 0.63) | 10.51 | 4100 | 6.85 | 3.76 |
| Example 6 | | | | | | |
| Inventive | 5.17 | (0.26, 0.64) | 9.45 | 3400 | 5.74 | 3.78 |
| Example 7 | | | | | | |
| Comparative | 6.51 | (0.27, 0.63) | 8.23 | 5200 | 3.97 | 2.92 |
| Example 4 | | | | | | |
| Comparative | 4.39 | (0.26, 0.64) | 11.53 | 2700 | 8.25 | 4.13 |
| Example 5 | | | | | | |

As shown in Table 6, the organic EL device in Inventive Example 6 exhibits a substantial decrease in drive voltage as well as increases in luminous efficiency, power efficiency, and external quantum efficiency over the organic EL device in Comparative Example 4. In addition, the organic EL device in Inventive Example 6 does not exhibit great decreases in luminous efficiency, power efficiency, and external quantum efficiency as compared to the organic EL device in Comparative Example 5, while exhibiting very little increase in drive voltage. Moreover, the organic EL device in Inventive Example 6 exhibits a substantial improvement in luminescent lifetime over the organic EL device in Comparative Example 5. In other words, using NPB and tBuDPN as the materials of the light emitting layer 5 to provide green emission resulted in the similar effects as those for the organic EL devices in Inventive Example 1 and Inventive Example 2. Consequently, provision of the electron restricting layer 6 can be said as effective regardless of the materials of the light emitting layer 5.

It is further seen that also for the organic EL device in Inventive Example 7 including, instead of the electron restricting layer 6 and electron transporting layer 7, the electron restricting/transporting layer 67 made of a mixture of the materials of the electron transporting layer 6 and the electron transporting layer 7, it can provide a decrease in drive voltage and improvements in luminous characteristics over the Comparative Example 4, and also provide an improvement in luminescent lifetime over the Comparative Example 5.

### Comparisons Between Inventive Examples 8, 9 and Comparative Examples 6, 7

### Inventive Example 8 and Inventive Example 9

Organic EL devices in Inventive Example 8 and Inventive Example 9 are different from the organic EL device in Inventive Example 7 as follows.

In Inventive Example 8, for the light emitting layer 5, NPB was used as a host material and DBZR was used as a luminescent dopant. The organic EL device in Inventive Example 8 thus emits in orange. Note that 3 wt % of the luminescent dopant was doped.

In Inventive Example 9, for the light emitting layer 5, Alq₃ was used as a host material and DCJTB was used as a luminescent dopant. The organic EL device in Inventive Example 9 thus emits in red. Note that 3 wt % of the luminescent dopant was doped.

### Comparative Example 6 and Comparative Example 7

Organic EL devices in Comparative Example 6 and Comparative Example 7, respectively, are different from the organic EL devices in Inventive Example 8 and Inventive Example 9 as follows.

In each of Comparative Example 6 and Comparative Example 7, an electron transporting layer 7 made of BCPwas formed instead of the electron restricting/transporting layer 67.

(Evaluation)

The organic EL devices in Inventive Example 8 and Inventive Example 9 as well as Comparative Example 6 and Comparative Example 7 were measured at 20 mA/cm² for CIE chromaticity coordinates, luminous efficiency, luminescent lifetime, power efficiency, and external quantum efficiency. As used herein, the luminescent lifetime refers to the time it took for a luminance of 1000 cd/m² at the initial measurement to decrease to half.

Table 7 shows the conditions for each of the layers in the organic EL devices of Inventive Example 8 and Inventive Example 9 as well as Comparative Example 7 and Comparative Example 7, respectively. Table 8 shows the measurements of CIE chromaticity coordinates, luminous efficiencies, luminescent lifetimes, power efficiencies, and external quantum efficiencies for the organic EL devices of Inventive Example 8 and Inventive Example 9 as well as Comparative Example 7 and Comparative Example 7, respectively.

TABLE 7

| | | | | | | Electron | | | |
|---|---|---|---|---|---|---|---|---|---|
| | | | | | | Restricting | | | |
| | | | | | | Transporting | | | |
| | Hole | | Hole | Light Emitting | | Layer | | Electron | |
| | Injecting | | Transporting | Layer | | (BCP + Alq3) | | Transporting | |
| | Layer | | Layer | (40 nm) | | | Alq3 | Layer | |
| | CuPc | CFx | (NPB) | Host | Luminescent | Thickness | Content | (BCP) | Luminescent |
| | [nm] | [nm] | [nm] | Material | Dopant | [nm] | [%] | [nm] | Color |
| Inventive | 10 | 1 | 150 | NPB | DBzR | 10 | 20 | — | Orange |
| Example 8 | | | | | | | | | |
| Comparative | 10 | 1 | 150 | NPB | DBzR | — | — | 10 | |
| Example 6 | | | | | | | | | |
| Inventive | 10 | 1 | 150 | Alq3 | DCJTB | 10 | 20 | — | Red |
| Example 9 | | | | | | | | | |
| Comparative | 10 | 1 | 150 | Alq3 | DCJTB | — | — | 10 | |
| Example 7 | | | | | | | | | |

TABLE 8

| | | | Lumi- | | |
|---|---|---|---|---|---|
| | CIE | | nescent | | External |
| | Chromaticity | Luminous | Life- | Power | Quantum |
| | Coordinates | Efficiency | time | Efficiency | Efficiency |
| | [x, y] | [cd/A] | [h] | [Lm/W] | [%] |
| Inventive | (0.48, 0.46) | 9.90 | 4000 | 6.20 | 4.68 |
| Example 8 | | | | | |
| Comparative | (0.47, 0.46) | 12.40 | 3600 | 8.88 | 5.58 |
| Example 6 | | | | | |
| Inventive | (0.63, 0.37) | 1.58 | 1800 | 0.58 | 0.56 |
| Exampe 9 | | | | | |
| Comparative | (0.62, 0.37) | 1.63 | 1580 | 0.60 | 0.58 |
| Example 7 | | | | | |

It is seen from Table 8, that also for the organic EL devices in Inventive Example 8 and Inventive Example 9 each including the electron restricting/transporting layer 67 made of a mixture of the materials of the electron restricting layer 6 and electron transporting layer 7, they can provide improvements in luminescent lifetimes over the organic EL devices in Comparative Example 6 and Comparative Example 7, respectively, without great decreases in their external quantum efficiencies. In particular, for the organic EL device in Inventive Example 9, the luminous characteristics are hardly deteriorated as compared to the organic EL device in Comparative Example 7.

### Comparisons Between Inventive Example 10 to Inventive Example 12 and Comparative Examples 8, 9

### Inventive Example 10

An organic EL device in Inventive Example 10 is different from the organic EL device in Inventive Example 2 as follows.

In Inventive Example 10, a hole transporting layer 3b made of CuPc (copper phthalocyanine) was formed between hole injecting electrode 2 and hole transporting layer 3a by vacuum deposition. The hole transporting layer 3b has a thickness of 10 nm, and the hole transporting layer 3a has a thickness of 1 nm.

An orange light emitting layer 5a with a thickness of 10 nm was formed by doping NPB as a host material with 3 wt % DBZR as a luminescent dopant.

A blue light emitting layer 5b with a thickness of 40 nm was formed by doping TBADN as a host material with 2 wt % TBP as a luminescent dopant.

### Inventive Example 11

An organic EL device in Inventive Example 11 is different from the organic EL device in Inventive Example 10 as follows.

In Inventive Example 11, an electron transporting layer 7 and electron restricting layer 6 were formed in sequence on a blue light emitting layer 5b.

### Inventive Example 12

An organic EL device in Inventive Example 12 is different from the organic EL device in Inventive Example 10 as follows.

In Inventive Example 12, instead of the electron restricting layer 6 and electron transporting layer 7, an electron restricting/transporting layer 67 with a thickness of 10 nm was formed on a blue light emitting layer 5b by vacuum deposition. The electron restricting/transporting layer 67 was formed so as to contain 20 wt % Alq₃ for the whole of the electron restricting/transporting layer 67.

### Comparative Example 8

An organic EL device in Comparative Example 8 is different from the organic EL device in Inventive Example 10 in that an electron transporting layer 7 was not formed, and the electron restricting layer 6 was 10 nm thick.

### Comparative Example 9

An organic EL device in Comparative Example 9 is different from the organic EL device in Inventive Example 10 in that an electron restricting layer 6 was not formed, and the electron transporting layer 7 was 10 nm thick.

(Evaluation)

The organic EL devices in Inventive Example 10 to Inventive Example 12 as well as Comparative Example 8 and Comparative Example 9 were measured at 20 mA/cm² for drive voltage, CIE chromaticity coordinates, luminous efficiency, luminescent lifetime, power efficiency, and external quantum efficiency. As used herein, the luminescent lifetime refers to the time it took for a luminance of 5000 cd/m² at the initial measurement to decrease to half.

Table 9 shows the conditions of each of the layers in the organic EL devices of Inventive Example 10 to Inventive

Example 12 as well as Comparative Example 8 and Comparative Example 9, respectively. Table 10 shows the measurements of drive voltages, CIE chromaticity coordinates, luminous efficiencies, luminescent lifetimes, power efficiencies, and external quantum efficiencies for the organic EL devices of Inventive Example 10 to Inventive Example 12 as well as Comparative Example 8 and Comparative Example 9, respectively.

TABLE 9

| | | | | | | | | Electron | | | | |
|---|---|---|---|---|---|---|---|---|---|---|---|---|
| | | | | | | Blue Light | | Restricting | | | | |
| | | | | Orange Light | | Emitting Layer | | Transporting | | | | |
| | Hole | | Hole | Emitting Layer | | (TBADN + | | Layer | | Electron | Electron | Electron |
| | Injecting | | Transporting | (NPB + DBzR) | | TBP) | | (BCP + Alq3) | | Restricting | Transporting | Restricting |
| | Layer | | Layer | | DBzR | | TBP | | Alq3 | Layer | Layer | Layer |
| | CuPc | CFx | (NPB) | Thickness | Content | Thickness | Content | Thickness | Content | (Alq3) | (BCP) | (Alq3) |
| | [nm] | [nm] | [nm] | [nm] | [%] | [nm] | [%] | [nm] | [%] | [nm] | [nm] | [nm] |
| Inventive | 10 | 1 | 150 | 10 | 3 | 40 | 2 | — | — | 3 | 7 | — |
| Example | | | | | | | | | | | | |
| 10 | | | | | | | | | | | | |
| Inventive | 10 | 1 | 150 | 10 | 3 | 40 | 2 | — | — | — | 7 | 3 |
| Example | | | | | | | | | | | | |
| 11 | | | | | | | | | | | | |
| Inventive | 10 | 1 | 150 | 10 | 3 | 40 | 2 | 10 | 20 | — | — | — |
| Example | | | | | | | | | | | | |
| 12 | | | | | | | | | | | | |
| Comparative | 10 | 1 | 150 | 10 | 3 | 40 | 2 | — | — | 10 | — | — |
| Example 8 | | | | | | | | | | | | |
| Comparative | 10 | 1 | 150 | 10 | 3 | 40 | 2 | — | — | — | 10 | — |
| Example 9 | | | | | | | | | | | | |

TABLE 10

| | | CIE | | | | External |
|---|---|---|---|---|---|---|
| | Drive | Chromaticity | Luminous | Luminescent | Power | Quantum |
| | Voltage | Coordinates | Efficiency | Lifetime | Efficiency | Efficiency |
| | [V] | [x, y] | [cd/A] | [h] | [Lm/W] | [%] |
| Inventive | 5.91 | (0.30, 0.36) | 13.43 | 1350 | 7.13 | 6.99 |
| Example 10 | | | | | | |
| Inventive | 6.00 | (0.31, 0.37) | 12.88 | 1670 | 6.26 | 6.74 |
| Example 11 | | | | | | |
| Inventive | 5.64 | (0.34, 0.41) | 13.62 | 1150 | 7.58 | 6.55 |
| Example 12 | | | | | | |
| Comparative | 7.51 | (0.35, 0.38) | 11.05 | 3025 | 4.62 | 5.45 |
| Example 8 | | | | | | |
| Comparative | 4.77 | (0.34, 0.41) | 13.78 | 784 | 9.08 | 6.83 |
| Example 9 | | | | | | |

As shown in Table 10, the organic EL device in Inventive Example 10 exhibits a substantial decrease in drive voltage while exhibiting increases in luminous efficiency, power efficiency, and external quantum efficiency over the organic EL device in Comparative Example 8. In addition, the organic EL device in Inventive Example 10 has a luminous efficiency, power efficiency, and external quantum efficiency almost equal to those of the organic EL device in Comparative Example 9, with a relatively small increase in drive voltage. Moreover, the organic EL device in Inventive Example 10 exhibits a substantial improvement in luminescent lifetime over the organic EL device in Comparative Example 9. This demonstrates that by providing an electron restricting layer 6, an organic EL device using two light emitting layers for white emission can similarly provide a lower drive voltage and extended luminescent lifetime without deterioration in luminous characteristics.

In addition, the organic EL device in Inventive Example 11 has luminous characteristics almost equal to those of the organic EL device in Inventive Example 10. This demonstrates that the reverse arrangement of an electron restricting layer 6 and electron transport layer 7 also results in the similar effects.

It is further seen that also for the organic EL device in Inventive Example 12 including, instead of the electron restricting layer 6 and electron transporting layer 7, the electron restricting/transporting layer 67 made of a mixture of the materials of the electron transporting layer 6 and the electron transporting layer 7, it can provide a decrease in drive voltage and improvements in luminous characteristics over Comparative Example 8 while providing an improvement in luminescent lifetime over Comparative Example 9.

### Comparisons Between Inventive Example 13 and Comparative Example 10

### Inventive Example 13

An organic EL device in Inventive Example 13 is different from the organic EL device in Inventive Example 12 as follows.

In Inventive Example 13, for the orange light emitting layer 5a, CBP was used as a host material, and Ir(phq)₃ was used as a luminescent dopant. Note that 6 wt % of the luminescent dopant was doped.

### Comparative Example 10

An organic EL device in Comparative Example 10 is different from the organic EL device in Inventive Example 13 as follows.

In Comparative Example 10, an electron transporting layer 7 made of BCP was formed instead of the electron restricting/transporting layer 67.

(Evaluation)

The organic EL devices in Inventive Example 13 and Comparative Example 10 were measured at 20 mA/cm² for CIE chromaticity coordinates, luminous efficiency, luminescent lifetime, power efficiency, and external quantum efficiency. As used herein, the luminescent lifetime refers to the time it took for a luminance of 5000 cd/m² at the initial measurement to decrease to half.

Table 11 shows the conditions of each of the layers in the organic EL devices of Inventive Example 13 and Comparative Example 10, respectively. Table 12 shows the measurements of CIE chromaticity coordinates, luminous efficiencies, luminescent lifetimes, power efficiencies, and external quantum efficiencies for the organic EL devices of Inventive Example 13 and Comparative Example 10, respectively.

TABLE 11

| | | | | | | | | Electron | | |
|---|---|---|---|---|---|---|---|---|---|---|
| | | | | | | Blue Light | | Restricting | | |
| | | | | Orange Light | | Emitting Layer | | Transporting | | |
| | Hole | | Hole | Emitting Layer | | (TBADN + | | Layer | | Electron |
| | Injecting | | Transporting | (CBP + Ir(phq) 3) | | TBP) | | (BCP + Alq3) | | Transporting |
| | Layer | | Layer | | Ir(phq) 3 | | TBP | | Alq3 | Layer |
| | CuPc | CFx | (NPB) | Thickness | Content | Thickness | Content | Thickness | Content | (BCP) |
| | [nm] | [nm] | [nm] | [nm] | [%] | [nm] | [%] | [nm] | [%] | [nm] |
| Inventive | 10 | 1 | 150 | 10 | 6 | 40 | 2 | 10 | 20 | — |
| Example | | | | | | | | | | |
| 13 | | | | | | | | | | |
| Comparative | 10 | 1 | 150 | 10 | 6 | 40 | 2 | — | — | 10 |
| Example | | | | | | | | | | |
| 10 | | | | | | | | | | |

TABLE 12

| | | | Lumi- | | |
|---|---|---|---|---|---|
| | CIE | | nescent | | External |
| | Chromaticity | Luminous | Life- | Power | Quantum |
| | Coordinates | Efficiency | time | Efficiency | Efficiency |
| | [x, y] | [cd/A] | [h] | [Lm/W] | [%] |
| Inventive | (0.31, 0.39) | 13.02 | 4050 | 5.47 | 7.76 |
| Example 13 | | | | | |
| Comparative | (0.33, 0.39) | 14.82 | 3500 | 5.96 | 8.16 |
| Example 10 | | | | | |

As shown in Table 12, the organic EL device in Inventive Example 13 provided an improvement in luminescent lifetime over the organic EL device in Comparative Example 10, without great decreases in any of luminous efficiency, power efficiency, and external quantum efficiency. This demonstrates that anorganic EL device using a triplet luminescent material can similarly provide an improvement in luminescent lifetime without a decrease in luminous characteristics, by including the electron restricting/transporting layer 67 made of a mixture of the materials of the electron restricting layer 6 and electron transporting layer 7.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An organic electroluminescent device comprising, in sequence, a hole injecting electrode, light emitting layer, and electron injecting electrode; and
an electron transporting layer that encourages transport of electrons and an electron restricting layer that restricts transfer of electrons between said light emitting layer and said electron injecting electrode.

2. The organic electroluminescent device according to claim 1, wherein
said electron restricting layer is provided between said light emitting layer and said electron transporting layer.

3. The organic electroluminescent device according to claim 1, wherein
said electron restricting layer is provided between said electron transporting layer and said electron injecting electrode.

4. The organic electroluminescent device according to claim 1, wherein
said electron restricting layer has an energy level of the lowest unoccupied molecular orbital lower than that of said electron transporting layer.

5. The organic electroluminescent device according to claim 1, wherein
said electron restricting layer includes an organic compound having a molecular structure represented by a formula (1): 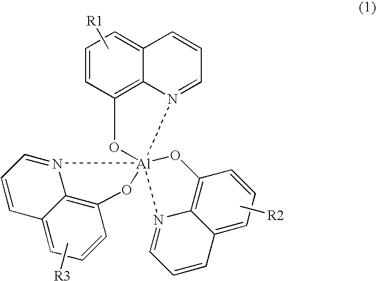
wherein R1, R2 and R3 are the same or different, each being a hydrogen atom, halogen atom or alkyl group.

6. The electroluminescent device according to claim 1, wherein
said electron restricting layer includes tris(8-hydroxyquinolinato)aluminum having a molecular structure represented by a formula (2):

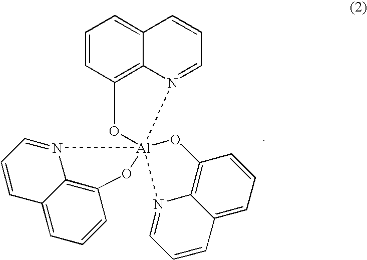

7. The electroluminescent device according to claim 1, wherein
said electron restricting layer includes an organic compound having a molecular structure represented by a formula (3): 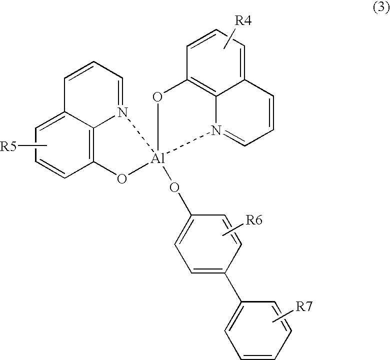
wherein R4, R5, R6 and R7 are the same or different, each being a hydrogen atom, halogen atom or alkyl group.

8. The organic electroluminescent device according to claim 1, wherein
said electron restricting layer includes an anthracene derivative.

9. The organic electroluminescent device according to claim 8, wherein
said electron restricting layer includes tert-butyl substituted dinaphthylanthracene having a molecular structure represented by a formula (4):

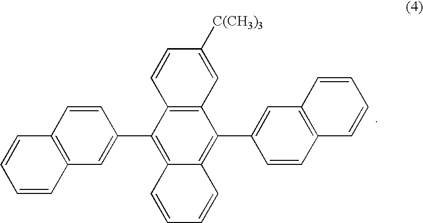

10. The organic electroluminescent device according to claim 1, wherein
said electron transporting layer includes a phenanthroline compound.

11. The organic electroluminescent device according to claim 1, wherein
said electron transporting layer includes 1,10-phenanthroline having a molecular structure represented by a formula (5) or a derivative thereof:

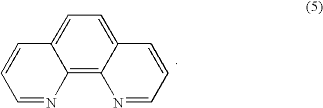

12. The organic electroluminescent device according to claim 1, wherein
said electron transporting layer includes a phenanthroline derivative having a molecular structure represented by a formula (6): 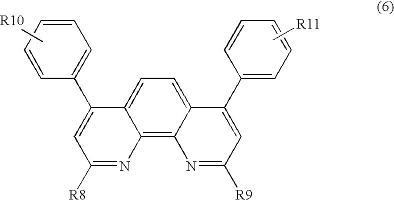
wherein R8, R9, R10 and R11 are the same or different, each being a hydrogen atom, halogen atom, aliphatic substituent or aromatic substituent.

13. The organic electroluminescent device according to claim 1, wherein
said electron transporting layer has 2,9-Dimethyl-4,7-diphenyl-1,10-phenanthroline having a molecular structure represented by a formula (7):

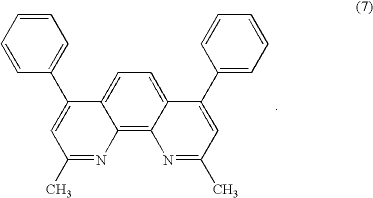

14. The organic electroluminescent device according to claim 1, wherein
said electron transporting layer includes a silole derivative having a molecular structure represented by a formula (8): 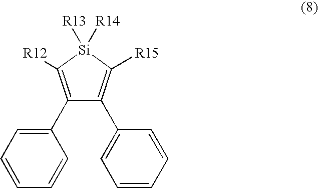
wherein R12, R13, R14 and R15 are the same or different, each being a hydrogen atom, halogen atom, aliphatic substituent or aromatic substituent.

15. The organic electroluminescent device according to claim 1, wherein
said light emitting layer includes a host material and a luminescent dopant.

16. The organic electroluminescent device according to claim 15, wherein
said host material includes any of an anthracene derivative, aluminum complex, rubrene derivative, and arylamine derivative.

17. The organic electroluminescent device according to claim 15, wherein
said luminescent dopant includes a material whose triplet excitation energy can be converted to emission.

18. The organic electroluminescent device according to claim 15, wherein
said host material includes tert-butyl substituted dinaphthylanthracene represented by said formula (4): 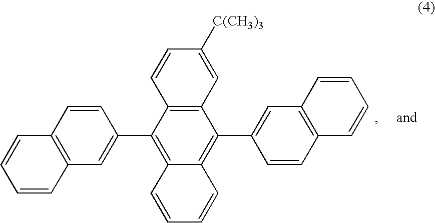
said luminescent dopant includes 1,4,7,10-Tetra-tert-butylPerylene represented by a formula (9):

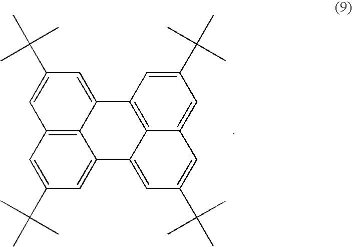

19. The organic electroluminescent device according to claim 15, wherein
said host material includes N,N′-Di(1-naphthyl)-N,N′-diphenyl-benzidine represented by a formula (10): 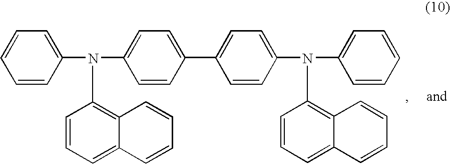
said luminescent dopant includes 5,12-Bis(4-tert-butylphenyl)-naphthacene represented by a formula (11):

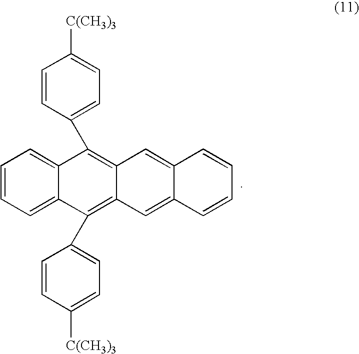

20. The organic electroluminescent device according to claim 1, wherein
said light emitting layer includes one or a plurality of layers.

21. The organic electroluminescent device according to claim 20, wherein
said light emitting layer includes a short-wavelength light emitting layer and a long-wavelength light emitting layer, wherein at least one of peak wavelengths produced by said short-wavelength light emitting layer is smaller than 500 nm, and at least one of peak wavelengths produced by said long-wavelength light emitting layer is greater than 500 nm.

22. The organic electroluminescent device according to claim 1, further comprising, between said hole injecting electrode and said light emitting layer, a hole transporting layer that encourages transport of holes.

23. The organic electroluminescent device according to claim 22, wherein
said light emitting layer includes a host material that is a same organic compound as said hole transporting layer.

24. The organic electroluminescent device according to claim 22, wherein
said hole transporting layer includes an arylamine derivative.

25. The organic electroluminescent device according to claim 22, wherein
said hole transporting layer includes N,N′-Di(1-naphthyl)-N,N′-diphenyl-benzidine represented by said formula (10): [chemical structure]
